(19) United States
(12) Patent Application Publication
(10) Pub. No.: US 2025/0286279 A1
(43) Pub. Date: Sep. 11, 2025

(54) PATCH ANTENNA TO REDUCE CROSS-POLARIZED RADIATION

(71) Applicant: Sonos Inc., Goleta, CA (US)

(72) Inventors: Hamid Reza MEMAR ZADEH TEHRAN, Melrose, MA (US); Gregory BEST, Bolton, MA (US); Kasra PAYANDEHJOO, Malden, MA (US)

(21) Appl. No.: 19/069,758

(22) Filed: Mar. 4, 2025

Related U.S. Application Data
(60) Provisional application No. 63/563,619, filed on Mar. 11, 2024.

(51) Int. Cl. H01Q 9/04; H01Q 1/22; H01Q 3/34; H01Q 19/00

(52) U.S. Cl. CPC H01Q 9/0407; H01Q 1/2208; H01Q 3/34; H01Q 19/005

(57) ABSTRACT

A playback device is configured to transmit and receive signals via a patch antenna coupled to a wireless radio. The patch antenna is configured to reduce cross-polarized radiation and comprises an electrically conductive ground plane, a substrate disposed on the ground plane, and a radiator disposed on the substrate. The radiator comprises a first portion and a second portion, wherein the first portion of the radiator is coupled through an opening in an interior region of the patch antenna to a first leg of a differential feed. The differential feed is configured to provide a signal to drive the radiator. The patch antenna also comprises a delay element, wherein the second portion of the radiator is coupled via the delay element and further through the opening of the patch antenna to a second leg of the differential feed.

### CROSS REFERENCE TO RELATED APPLICATIONS

This application claims the benefit of priority under 35 U.S.C. § 119(e) to U.S. Provisional Application Ser. No. 63/563,619, titled “PATCH ANTENNA TO REDUCE CROSS-POLARIZED RADIATION,” filed on Mar. 11, 2024, the contents of which are incorporated by reference herein in their entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 7 is a schematic diagram illustrating an example home theater environment.

FIG. 8 illustrates radios and antenna switching for a playback device.

FIG. 9 illustrates an example patch antenna.

FIG. 10 illustrates another example patch antenna.

FIG. 11 illustrates another example patch antenna.

FIG. 12 illustrates another example patch antenna.

FIG. 13 illustrates simulation results for an example three port network.

FIG. 14 illustrates simulated radiation patterns for an example patch antenna.

FIG. 15 is a flowchart illustrating an example method for driving a patch antenna. The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

SONOS, Inc. has a long history of innovating in the wireless audio space as demonstrated by the successful launch of numerous wireless audio products including, for example, SONOS ROAM, SONOS MOVE, SONOS ERA 100, SONOS ERA 300, SONOS FIVE, SONOS RAY, SONOS BEAM, SONOS ARC, SONOS PORT, and SONOS AMP. Building upon years of experience creating sophisticated, yet easy-to-use, audio products, SONOS, Inc. has appreciated the importance of providing a high quality user experience. This high quality user experience includes reliable wireless communications and energy efficient operation. Reliable wireless communications are important both for ease of installation and setup, and for seamless operation (e.g., avoiding audio dropouts). Energy efficient operation is important to prolong battery life (e.g., in battery operated portable devices) and reduce the carbon emissions associated with operation of an electronic device over its lifetime (and/or improve the environmental sustainability of the electronics device).

Patch antennas may be suitable for use in playback devices as they have a low profile, operate efficiently at microwave frequencies, including ultrawideband (UWB) frequencies, and can be conveniently fabricated on circuit boards. Patch antennas may be configured to generate and/or detect radiation with a specific polarization (e.g., linear polarization, circular polarization, elliptical polarization, etc.) along a particular set of one or more directions, such as a boresight of the patch antenna (e.g., a direction that is perpendicular to the plane of the antenna). Patch antennas are typically driven by a single feed source that is connected at one point along an outer edge of the patch antenna. Such patch antennas may be used for any of a variety of applications in the context of playback devices such as, for example, UWB antennas employed in a system that facilitates determination of the relative positions of playback devices as described in, for example, International Patent Publication No. WO 2023/056343 entitled, “Use of an Ultra-Wideband (UWB) Radio in Playback Devices,” which is incorporated herein by reference in its entirety.

While idealistic models of patch antennas that are polarized only generate radiation with the intended polarization (e.g., co-polarized radiation), actual implementations of patch antennas also emit radiation with a different (or unintended) polarization (e.g., cross-polarized radiation). The cross-polarized radiation generally represents “wasted” energy because the intended receiving antenna is typically constructed to primarily detect the co-polarized radiation and ignore radiation with other polarizations. As the proportion of transmit energy that goes toward generation of cross-polarized radiation increases, more power is required to achieve a given magnitude of desirable co-polarized radiation. Accordingly, the power efficiency of the communication system typically improves as the cross-polarized radiation from the antenna is reduced.

The cross-polarized radiation emissions of a patch antenna are, in part, caused by an imbalance of the electric fields along the radiation edges of the patch antenna. For instance, the electric field in an actual patch antenna along a radiating edge near one corner of the patch antenna may be substantially higher (e.g., 10%+ higher, 20%+ higher, etc.) than the electrical field along an opposite radiating edge near an opposite corner (e.g., as measured in Volts per meter). As the imbalance between these electric fields increases, the amount of cross-polarized radiation generally also increases.

To this end, embodiments described herein relate to an improved patch antenna design that decreases undesirable cross-polarized radiation through improved balance of the electric fields along the radiating edges of the patch antenna. In some embodiments, the improved balance of the electric fields (and reduced cross-polarized radiation) is achieved through the use of multiple feeds with some phase shift between the feeds (e.g., differential feeds with a 180 degree phase shift between the feeds) that are connected at different points of the patch antenna. Such a feeding technique (e.g., multiple feed sources at different points along the patch with a phase shift between the feeds) can improve the balance of the electric fields and achieve full (or near full) cancellation of the cross-polarized radiation.

In some implementations, an opening may be incorporated into the patch antenna near the center creating one or more inner edges to the patch. Given that the magnitude of the electric fields is typically zero (or near zero) at the center of the patch, the integration of an opening at the center of the patch has a negligible impact on performance. In turn, the location of the feed source can be modified to connect to the patch antenna along one or more of the inner edges of the patch (e.g., instead of to an external edge). This approach should reduce the cross polarized radiation given that feeding from external edges can have an adverse effect on co-polarized radiation by way of disrupting fringing fields along the radiating edges of the patch antenna.

Further, any element(s) that may be employed to achieve the phase shift (e.g., a delay element) may be incorporated into the opening of the patch antenna. Such a design advantageously reduces the footprint of the patch antenna and accompanying circuitry (e.g., on a circuit board).

In some embodiments, for example, a playback device comprises a patch antenna and a wireless radio coupled to the patch antenna via a differential feed. The patch antenna includes an electrically conductive ground plane, a substrate disposed on the ground plane, and a radiator disposed on the substrate. The radiator comprises a first portion and a second portion. The first portion of the radiator is coupled through an opening in an interior region of the patch antenna to a first leg of the differential feed configured to provide a signal to drive the radiator. The patch antenna further comprises a delay element, wherein the second portion of the radiator is coupled via the delay element and further through the opening of the patch antenna to a second leg of the differential feed. The playback device further comprises at least one processor, and at least one non-transitory computer-readable medium. Program instructions stored on the non-transitory computer-readable medium that are executable by the at least one processor such that the primary playback device is configured to, based on signals received via the patch antenna from another playback device, determine a relative location of the playback device to the other playback device based on timing of those signals, and operate in a playback configuration where the playback device plays back one or more channels of multi-channel audio content, the playback configuration based on the determined relative location.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

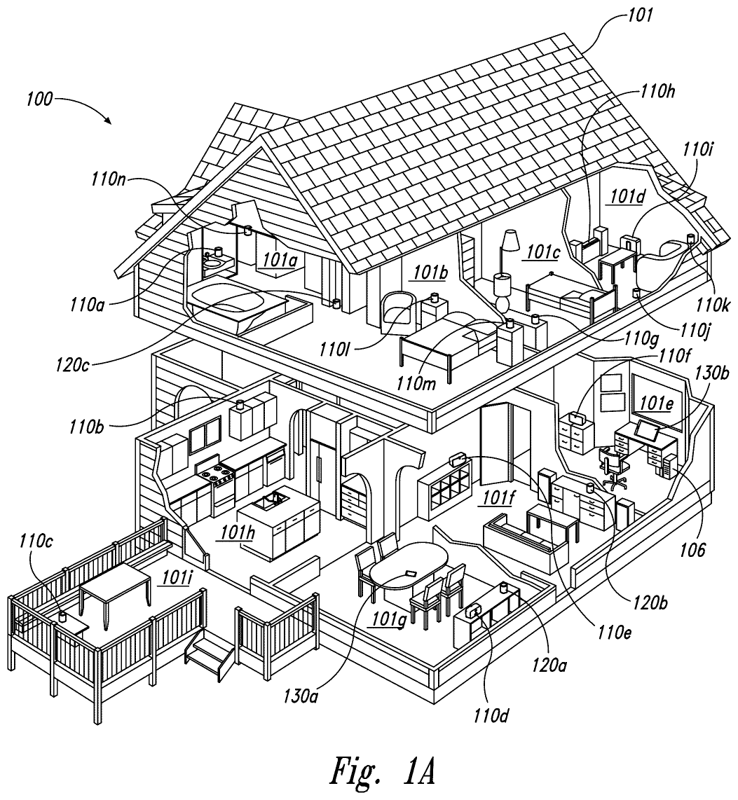

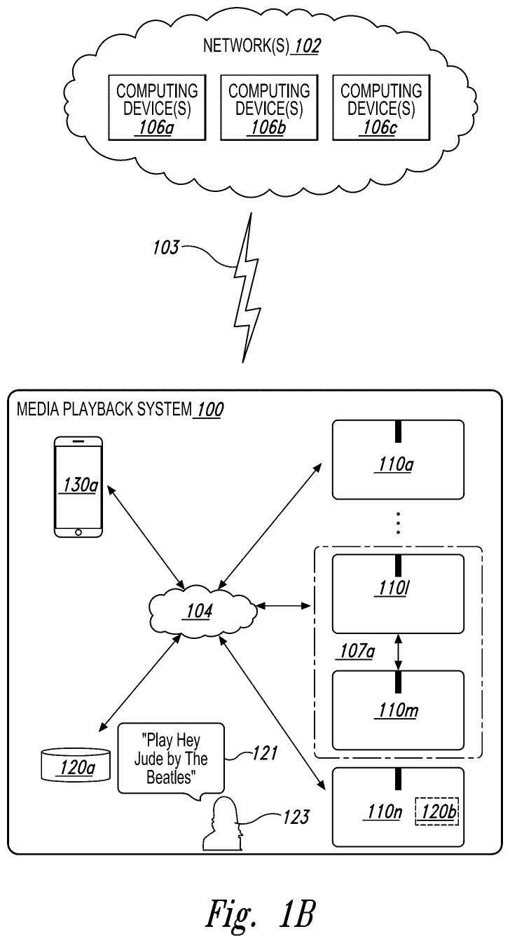

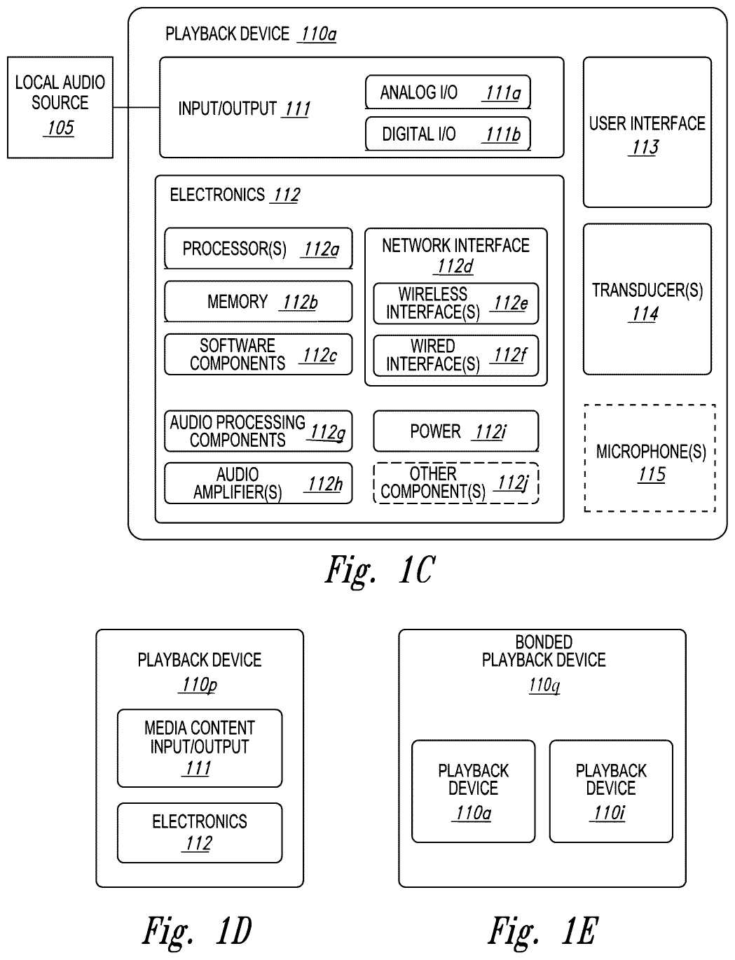

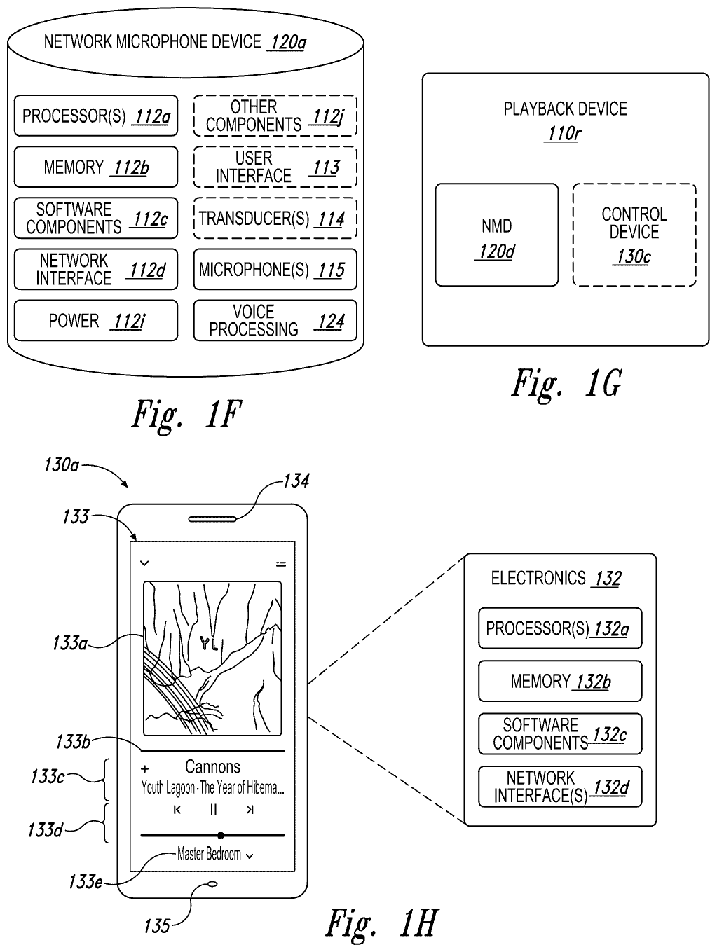

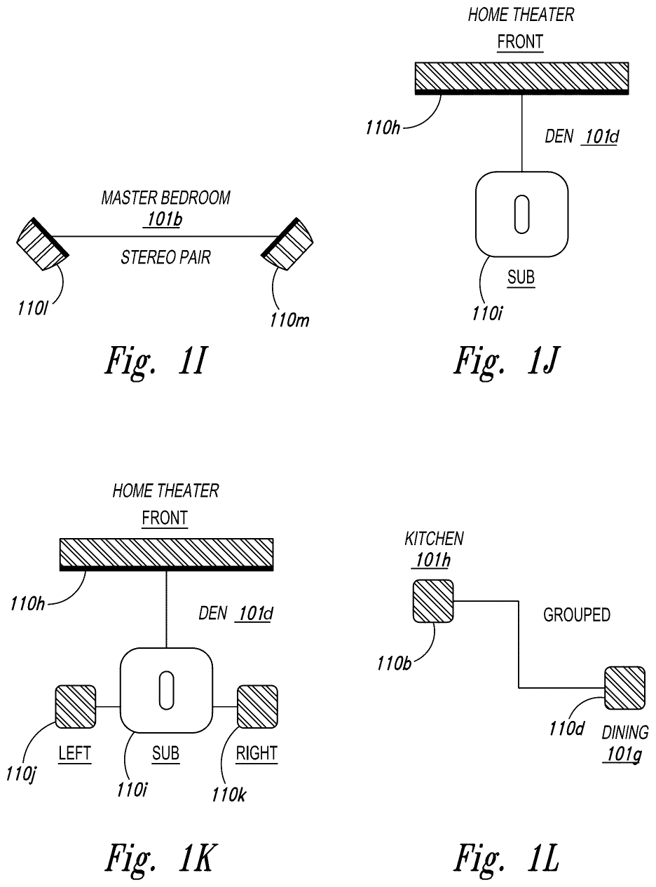

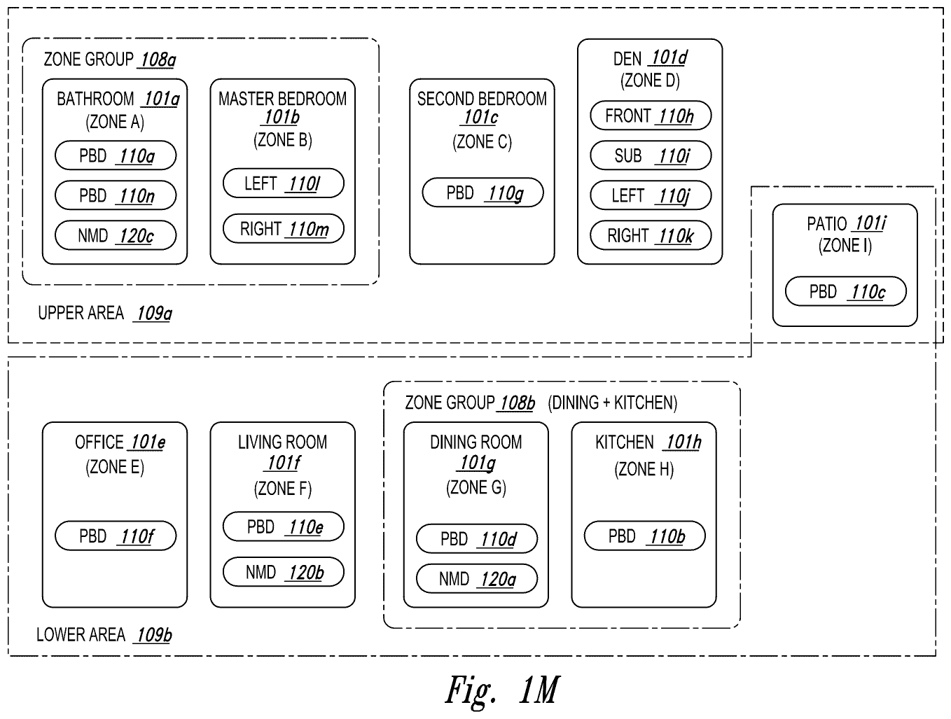

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k)can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

### a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I-1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

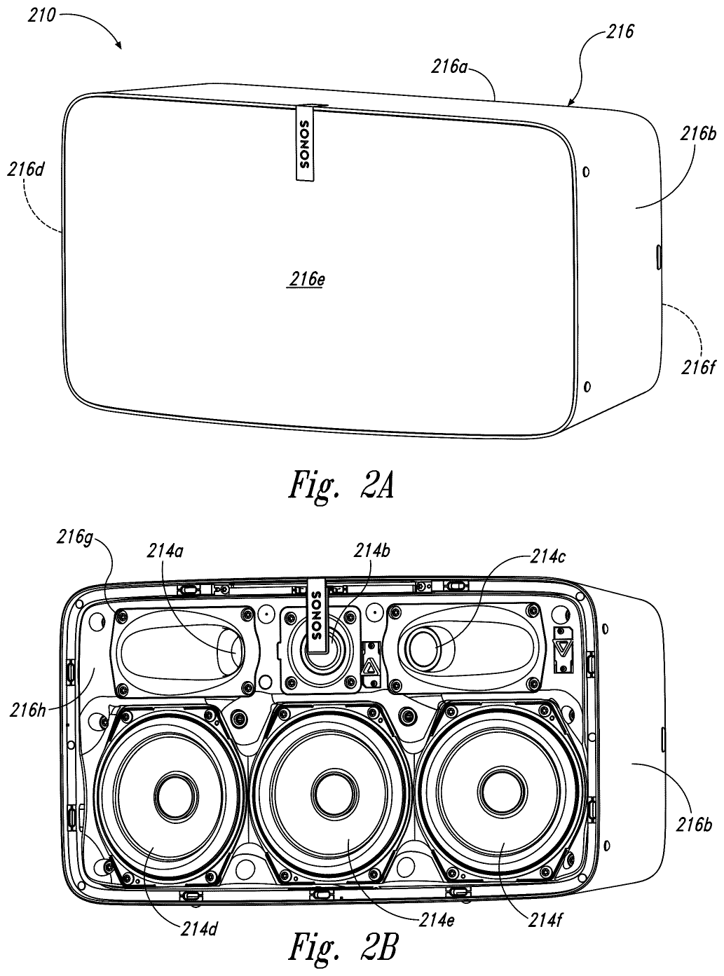

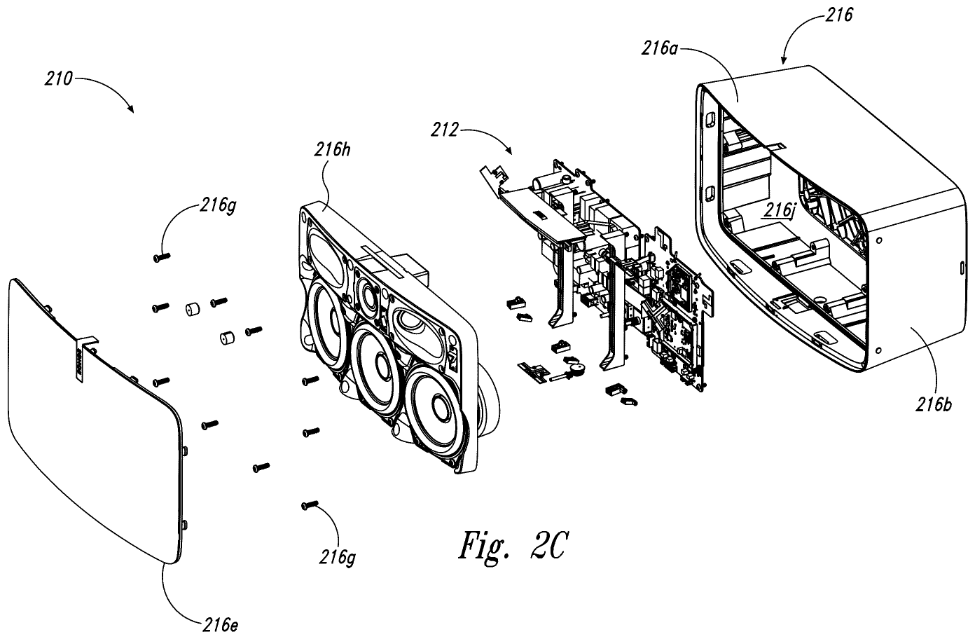

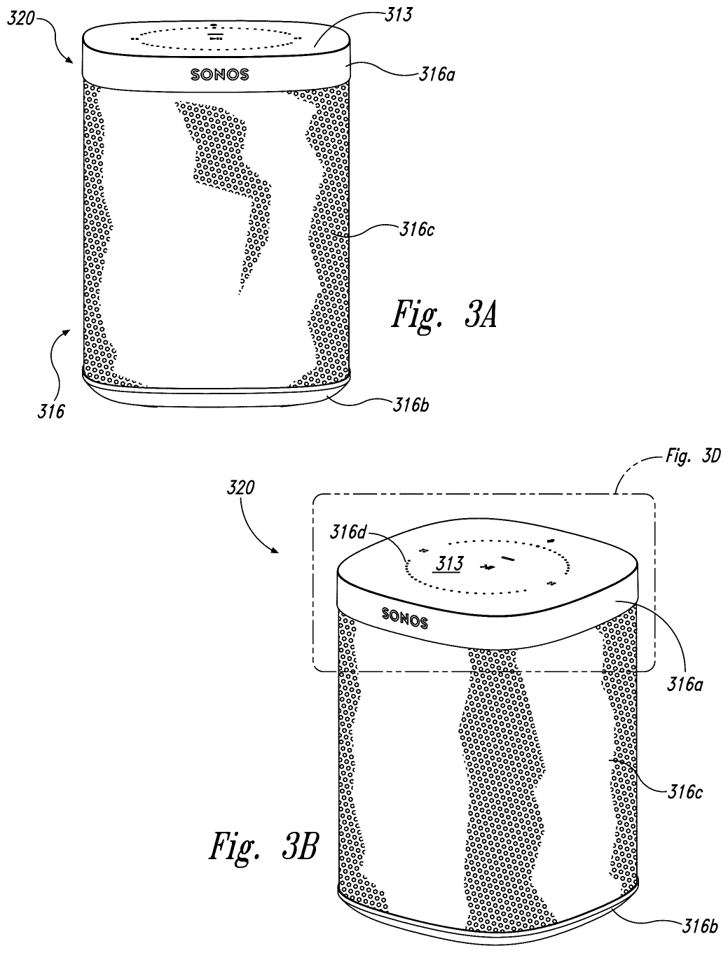

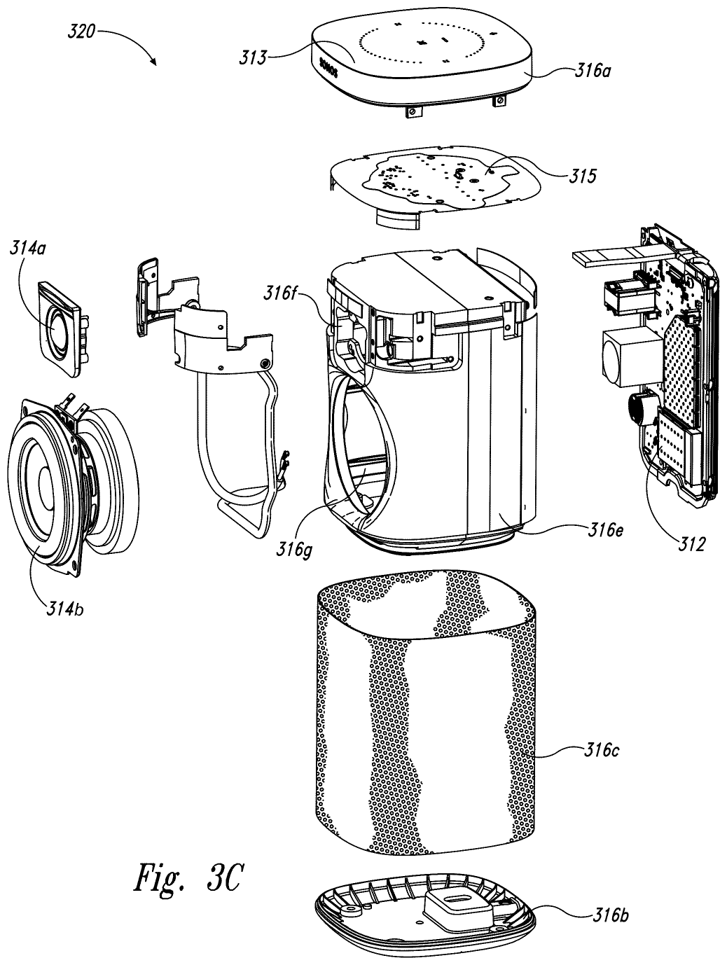

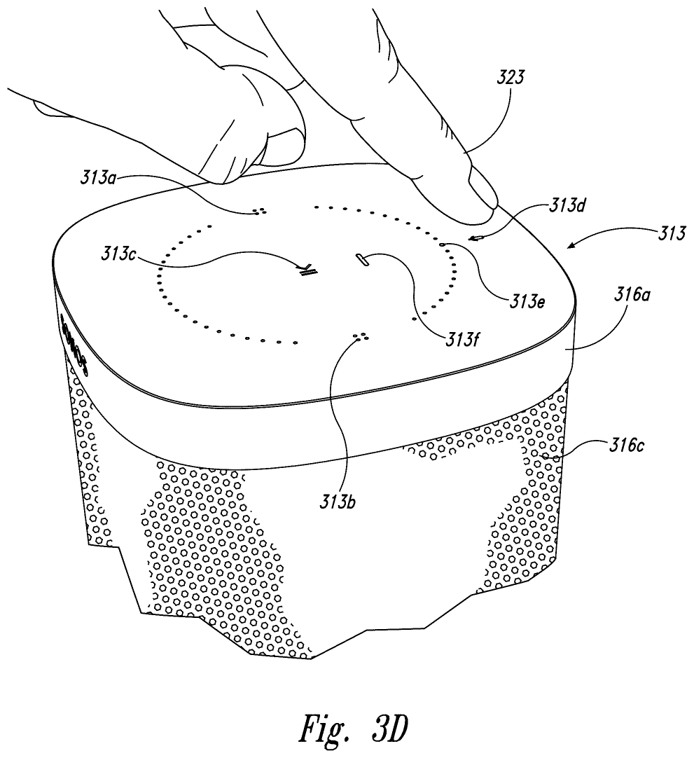

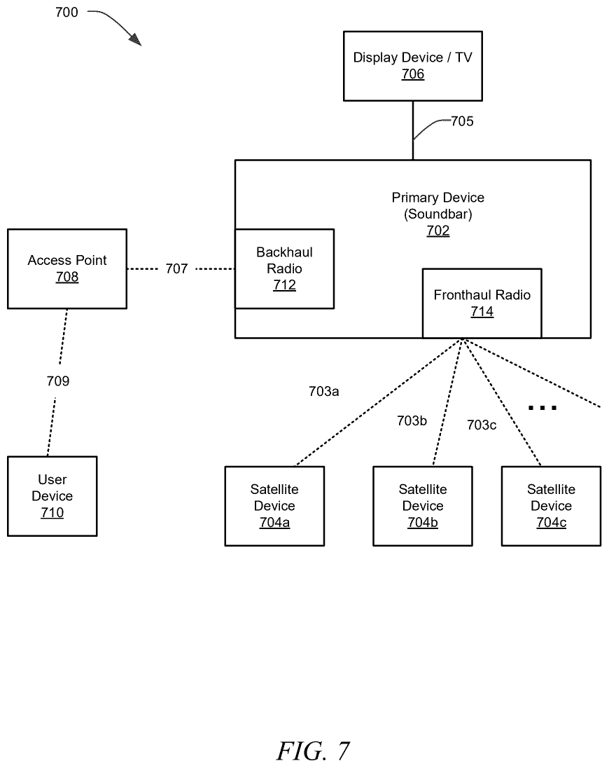

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.”

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B). Additional NMD embodiments are described in further detail below with respect to FIGS. 3A-3D.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3D.

### d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

### e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Pat. No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining +Kitchen zone group 108b and that devices 110b and 110d are grouped (FIG. 1L). Identifiers associated with the Kitchen may indicate the same or similar information by virtue of the Kitchen being part of the Dining +Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) are configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In some examples, a filter is axially aligned with the transducer 214b. The filter can be configured to desirably attenuate a predetermined range of frequencies that the transducer 214b outputs to improve sound quality and a perceived sound stage output collectively by the transducers 214. In some embodiments, however, the playback device 210 omits the filter. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to receive sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to Figure IF such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control) that can be adjusted by a user 323. A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

### IV. Example Home Theater Environments

FIG. 7 illustrates an example of a home theater environment 700. As shown, home theater environment 700 comprises a display device 706, such as a television or monitor, that displays visual content and outputs audio content that is associated with the displayed visual content via a communication link 705 to a primary playback device 702 (for example, a soundbar, a smart television box, a smart television stick, and so forth). Primary playback device 702 is capable of receiving audio via an audio input interface from a television, media player (for example, set-top box, streaming media playback device, computer), or other home theater source. Further, primary playback device 702 may operate as a sourcing device for a bonded zone (for example, a home theater group) that includes one or more satellite playback devices, also referred to herein as “satellites.” The satellites may play back certain channels (for example, playback devices 110j and 110k) and/or certain frequency ranges (for example, playback device 110i), as shown, for example, in FIGS. 1K and 1J illustrating den 101d.

Primary playback device 702 includes a first radio 712 (also referred to as a “backhaul radio”) and, using first radio 712, communicates with an access point (AP) 708 via a communication link 707 (for example, a backhaul connection). Additionally, primary playback device 702 includes a second radio 714 (also referred to as a “fronthaul radio”) and, using second radio 714, communicates with one or more satellite playback devices 704a, 704b, 704c, . . . via one or more communication links 703a, 703b, 703c. Access point 708, in turn, communicates with other devices such as a user device 710 (for example, a smartphone, tablet, laptop, desktop computer, and so forth) via a communication link 709. In some examples, primary playback device 702 may be integrated with display device 706, for example a television may include a smart soundbar.

In some instances, home theater environment 700 may play back audio from a music streaming service. In such instances, primary playback device 702 may communicate with one or more cloud servers associated with a music service provider (for example, via communication link 707 to access point 708) to obtain the audio content for playback. After receipt of the audio content for playback, primary playback device 702 may communicate the audio content (or any portion thereof) to satellite playback devices 704a, 704b, 704c, for synchronous playback via communication links 703a, 703b, 703c. In examples where primary playback device 702 is implemented as a soundbar (or otherwise comprises transducers for rendering audio content), primary playback device 702 may render the audio content in synchrony with satellite playback devices 704a, 704b, 704c. In such examples, primary playback device 702 and satellite playback devices 704a, 704b, 704c form a home theater bonded zone or group, as discussed above with reference to FIG. 1J, for example. In examples where primary playback device 702 is implemented as a smart television box or smart television stick (or otherwise does not comprise transducers for rendering audio content), satellite playback devices 704a, 704b, 704c may render the audio content in synchrony with each other while primary playback device 702 may not render the audio content. In such examples, satellite playback devices 704a, 704b, 704c form a home theater bonded zone.

In some instances, primary playback device 702 and satellite playback devices 704a, 704b, 704c may render audio content in lip-synchrony with associated visual content displayed by display device 706. In such examples, primary playback device 702 may receive audio content from display device 706. For example, primary playback device 702 and display device 706 can include analog and/or digital interfaces that facilitate communicating the audio content (for example, multichannel audio content) such as a SPDIF RCA interface, an HDMI interface (for example, an audio return channel (ARC) HDMI interface), an optical interface (for example, a TOSLINK interface), and so forth. In such examples, communication link 705 may comprise a wired connection (for example, an SPDIF cable, an HDMI cable, a TOSLINK cable, and so forth). In other examples, primary playback device 702 and display device 706 may include wireless circuitry that facilitates wirelessly communicating the audio content from display device 706 to primary playback device 702. In such examples, communication link 705 may be a wireless communication link such as a WI-FI link, BLUETOOTH link, ZIGBEE link, Z-WAVE link, and/or wireless HDMI link.

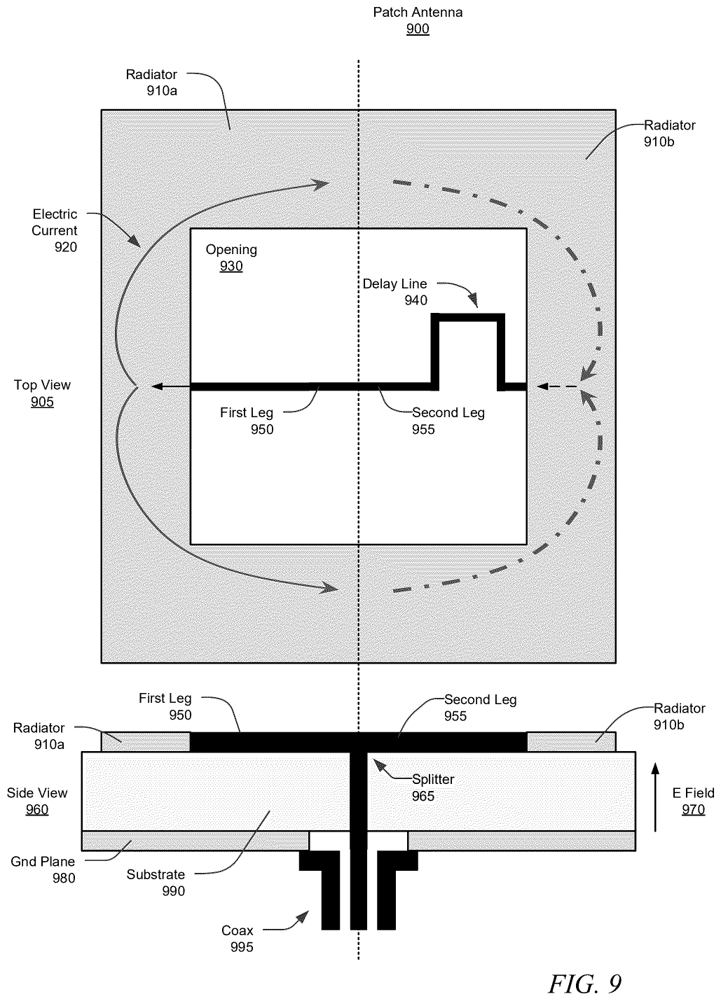

After receipt of the audio content associated with visual content to be rendered by display device 706, primary playback device 702 may communicate the received audio content (or any portion thereof) to satellite playback devices 704a, 704b, 704c (for example, via communication links 703a, 703b, 703c). Any of a variety of methodologies may be employed to communicate the audio content to satellite playback devices 704a, 704b, 704c, including a wireless radio and patch antenna, as described in more detail below with respect to FIGS. 9-12. Once the audio content has been communicated to satellite playback devices 704a, 704b, 704c satellite playback devices 704a, 704b, 704c (and/or primary playback device 702) may render the audio content in synchrony with each other and in lip-synchrony with visual content displayed on display device 706. For instance, in examples where primary playback device 702 is implemented as a soundbar (or otherwise comprises transducers for rendering audio content), primary playback device 702 may render the audio content in synchrony with satellite playback devices 704a, 704b, 704c and in lip-synchrony with the visual content displayed on display device 706. In examples where primary playback device 702 is implemented as a smart television box or smart television stick (or otherwise does not comprise transducers for rendering audio content), satellite playback devices 704a, 704b, 704c may render the audio content in synchrony with each other and in lip-synchrony with the display of visual content on display device 706 while the primary playback device 702 may not render the audio content.

In some embodiments, primary playback device 702 may also be configured to operate as an access point and/or as a router (for example, a mesh router) that client devices (for example, separate and apart from devices in home theater environment 700) may be able to connect to for network access (for example, access to a Wide Area Network (WAN) such as the Internet). For instance, primary playback device 702 may be configured as a wireless mesh router that integrates into a mesh router system to extend the range of the mesh router system. Such mesh router systems are becoming increasingly advantageous with the deployment of countless Internet-of-Things (IoT) devices in spaces (for example, residential and/or commercial spaces).

### V. Example Communication System for UWB Using a Patch Antenna

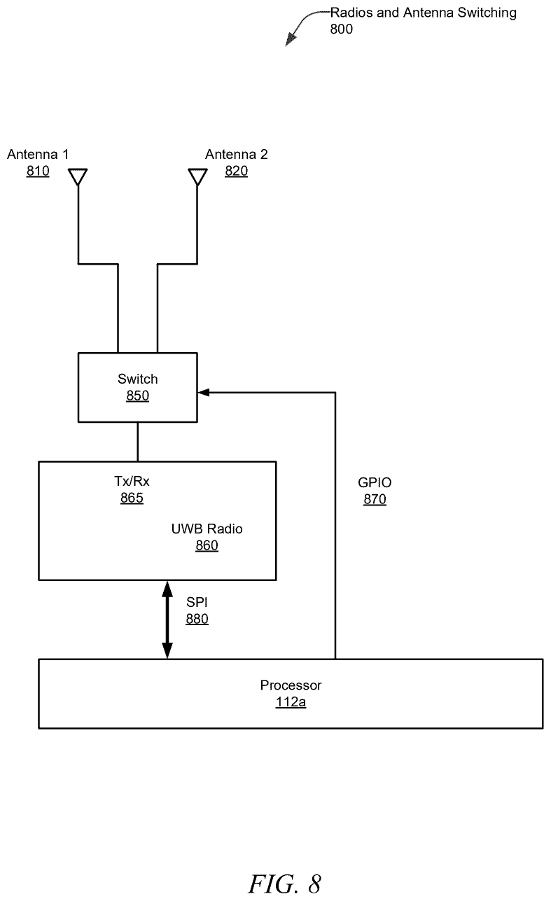

FIG. 8 illustrates radios and antenna switching 800 for a playback device configured in accordance with aspects of the disclosed technology. Referring to FIG. 8, the playback device is shown to include a first antenna 810, a second antenna 820, a switch 850, a UWB radio 860, and processor 112a. In some embodiments, the processor 112a is configured to communicate with the UWB radio 860 over a serial peripheral interface (SPI) bus 880. In some embodiments, the processor 112a is configured to control switch 850 by issuing control signals to the switch over a general purpose I/O (GPIO) bus GPIO 870.

In some embodiments, UWB radio 860 is configured to selectively transmit or receive UWB signals, through either of antennas 810 or 820, under the control of processor 112a. In transmit mode, signals are routed from the transmit/receive port 865 of the UWB radio 860 to one of the antennas 810 or 820, based on control signals applied by the processor to switch 850. In receive mode, signals are routed from one of the antennas 810 or 820 to the transmit/receive port 865 of the UWB radio 860 based on control signals applied by the processor to switch 850. Thus, an RF path can be established between the transmit/receive port 865 and one of the antennas 810 or 820. In some embodiments, additional antennas and switches may be employed to provide even greater flexibility in antenna selection for transmission and reception of signals.

The UWB radio 860 is further configured to accept a signal (e.g., a baseband signal) from the processor (e.g., over the SPI bus 880), in transmit mode, and generate an RF UWB signal for transmission through the selected antenna. In receive mode, the UWB radio 860 is further configured to receive an RF UWB signal through the selected antenna and convert that signal to baseband to be provided to the processor (e.g., over the SPI bus 880).

In some embodiments, the UWB radio 860 may be used to transmit instructions from one playback device to other playback devices. The instructions may include instructions to set playback configurations, for example to select channels from multi-channel audio content or for any other suitable purpose.

The antennas may be constructed in any of a variety of ways and may (or may not) have the same construction. In some instances, the antennas may comprise one or more omnidirectional antennas (e.g., antennas with an omnidirectional radiation pattern). Additionally (or alternatively), the antennas may comprise one or more directional antennas (e.g., antennas with a directional radiation pattern). The particular construction of the antennas may vary based on the particular implementation. For instance, the antennas may comprise one or more monopole antennas (e.g., configured as omni directional antennas) and/or one or more patch antennas (e.g., configured as directional antennas). In some instances, the antennas may comprise patch antennas configured to reduce cross-polarized radiation, as described below in connection with FIGS. 9-15.

In some embodiments, the RF signals are UWB signals (e.g., signals characterized by a center frequency in the range of 3.1-10.6 GHz and a bandwidth greater than the lesser of 500 MHz or 20% of the center frequency).

### VI. Example Systems, Devices, and Methods for Patch Antennas

FIG. 9 illustrates an example patch antenna 900 which is configured to reduce cross-polarization, as previously discussed. The patch antenna may be incorporated in a playback device (e.g., primary device 702 and/or satellite devices 704) for receiving and transmitting signals via a wireless radio (e.g., radios 712 and/or 714). The patch antenna 900 is shown in a top view 905 and a cross-sectional side view 960 taken along the dashed line shown in the top view 905.

The patch antenna 900 includes a radiator that is shown to comprise a first portion 910a and a second portion 910b. In some examples, each of the portions may comprise approximately one half of the total area of the radiator. The radiator portions are mounted, or otherwise disposed, on a substrate 990. In some examples, the substrate is a dielectric material. In some embodiments, the substrate may be a printed circuit board (PCB), a flexible printed circuit (FPC), polyimide, or similar material for mounting the radiating elements thereon. The patch antenna also includes an electrically conductive ground plane 980, upon which the substrate 990 is disposed.

The radiator is driven by a signal that is provided through a differential feed, which in this example is shown as a coaxial cable 995. The outer grounding shield of the coaxial cable 995 is coupled to the ground plane 980. The inner signal line of the coaxial cable is coupled to a splitter 965 which provides the signal to the two portions of the radiator, as will be described in greater detail below. As shown, the inner signal line may be connected to the splitter 965 via an electrical path that passes through the substrate 990, such as a via. The radiator generates an electric current 920 and an electric field 970 in response to the driving signal. The electric current 920 is shown to circulate through the plane of the radiator, in the top view 905. The electric field 970 is shown to radiate along the edges of the patch antenna and perpendicular to the plane of the radiator, in the side view 960.

An opening 930 is located in the interior region of the patch antenna. In some examples, the opening 930 is centrally located within the patch antenna. Given that the electric field is zero (or near-zero) near the center of the patch antenna during operation, the opening 930 can be incorporated into the design without significant performance compromises. The opening 930 may advantageously reduce the footprint of the patch antenna 900 and associated components by providing a space into which one or more elements may be incorporated, such as delay line 940 as described in more detail below.

The first portion 910a of the radiator is coupled through the opening 930 to a first leg 950 of the differential feed. The first leg 950 is coupled to a first port of the splitter 965. The second portion 910b of the radiator is coupled through the opening 930 to a second leg 955 of the differential feed. The second leg 955 is coupled to a second port of the splitter 965. In some examples, the first leg 950 and the second leg 955 may be configured to have the same (or similar) impedances to achieve a balance in signal power delivered to the first and second portions of the radiator.

The second leg 955 is shown to include a delay line 940 that is configured to introduce a phase shift to the signal that drives the second portion 910b of the radiator. The amount of phase shift is a function of the length of the delay line 940, and the phase shift is frequency dependent. In some examples, the length of the delay line is selected to provide a phase shift of 180 degrees in a frequency band of interest (e.g., the frequency band in which signals will be transmitted and received). While the particular frequency band of interest may vary based on the particular implementation, example frequency bands include those frequency bands employed in BLUETOOTH, UWB, 2.4 GHz WIFI, 5 GHz WIFI, and/or 6 GHz WIFI communication.

In some embodiments, the delay line is tunable to provide a variable delay to offer flexibility with respect to the choice of frequency bands. For instance, a first delay may be employed when communicating in a first frequency band and a second, different delay may be employed when communicating in a second frequency band.

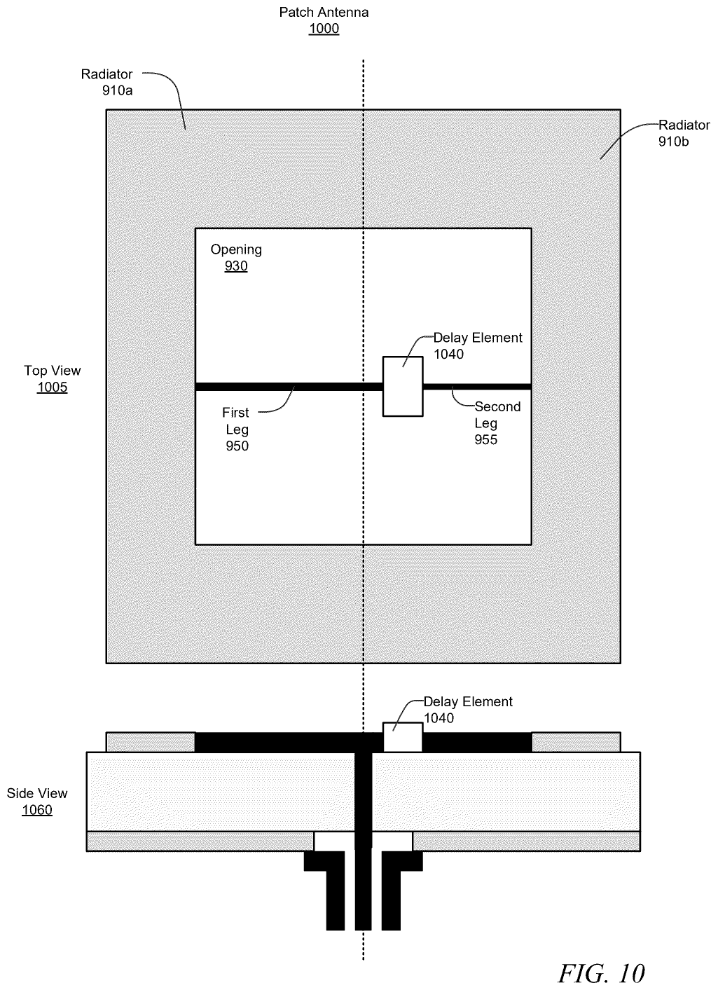

FIG. 10 illustrates another example patch antenna 1000. Relative to patch antenna 900, the delay line 940 is replaced with a delay element 1040. The patch antenna 1000 is shown in a top view 1005 and a cross-sectional side view 1060 taken along the dashed line shown in the top view 1005. Delay element 1040 is configured as a lumped element circuit comprising one or more capacitive elements and/or inductive elements configured to introduce a phase shift to the signal that drives the second portion 910b of the radiator.

The amount of phase shift introduced by the lumped element circuit is a function of the capacitance and/or inductance provided by the components of the delay element 1040. In some examples, the capacitive and inductive components of the delay element are selected to provide a phase shift of 180 degrees in the frequency band of interest. In some embodiments, the delay element is tunable to provide a variable delay to offer flexibility with respect to the choice of frequency bands.

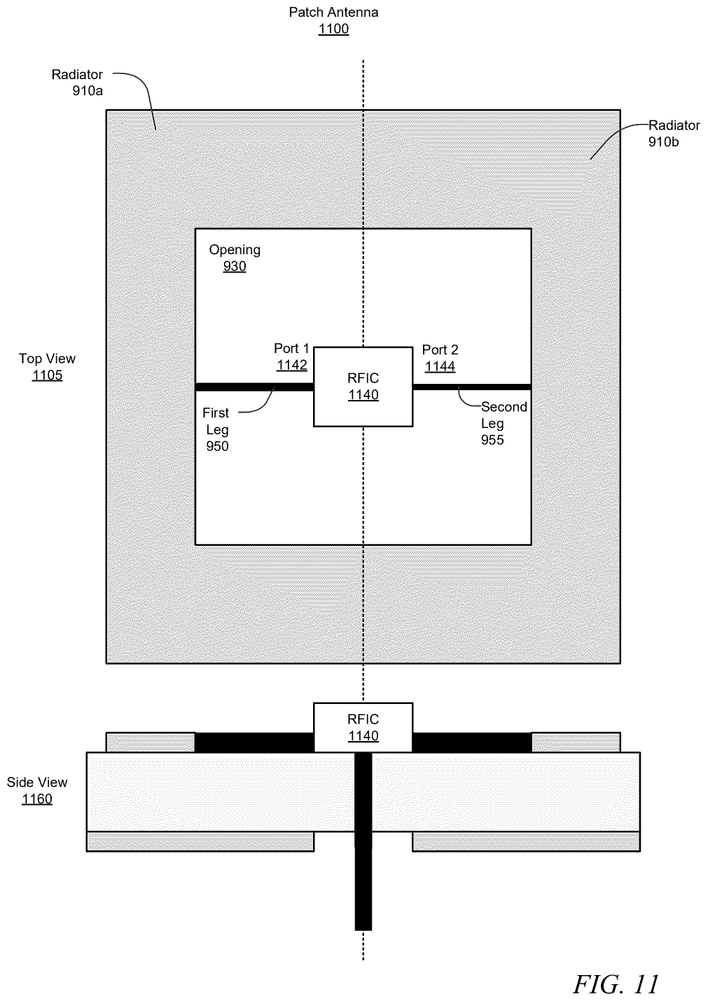

FIG. 11 illustrates another example patch antenna 1100. Relative to patch antenna 900, the functions of signal splitting and phase shifting are performed by a radio frequency integrated circuit (RFIC) 1140. The patch antenna 1100 is shown in a top view 1105 and a cross-sectional side view 1160 taken along the dashed line shown in the top view 1105. In this example, the RFIC 1140 is configured to split the signal between the two sections of the patch. The RFIC 1140 provides a non-phase shifted version of the signal at a first port 1142, which is coupled to the first leg 950. The RFIC 1140 also provides a phase shifted version of the signal at a second port 1144, which is coupled to the second leg 955. In some examples, the RFIC is configured to provide a phase shift of 180 degrees (e.g., at the second port 1144) in the frequency band of interest.

In some embodiments, the RFIC 1140 may also be configured to perform the function of the wireless radio (e.g., radios 712 and/or 714). In some examples, the RFIC 1140 may be located below both the patch antenna and the associated ground plane, for example if the size of the RFIC, when configured as a radio, is too large to fit within the opening 930.

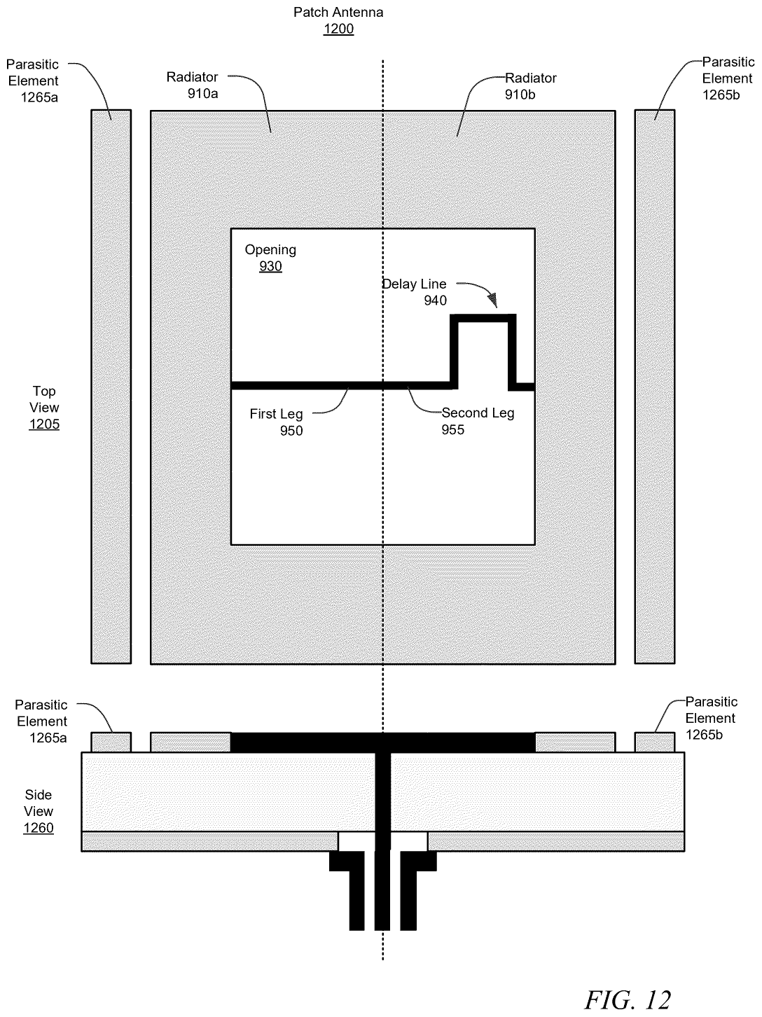

FIG. 12 illustrates another example patch antenna 1200. Relative to patch antenna 900, the patch antenna 1200 incorporates parasitic elements 1265a and 1265b to improve the bandwidth response of the patch antenna. Patch antenna 900 is shown in a top view 1205 and a cross-sectional side view 1260 taken along the dashed line shown in the top view 1205. In some embodiments, the parasitic elements 1265a and 1265b are positioned adjacent to, but spaced apart from, two opposite edges of the radiators, as shown. In some examples, the parasitic elements comprise an electrically conductive material.

It should be appreciated that the patch antennas described herein may be modified in other ways while still achieving the beneficial reduction in cross-polarized radiation emission. For example, the shape of the radiator itself and/or the opening may be modified. For instance, the radiator may have a circular and/or elliptical shape instead of a square and/or rectangular shape. Additionally (or alternatively), the opening may be a circular and/or elliptical shape instead of a square and/or rectangular shape. Further, the opening may be removed altogether in some implementations. For instance, any components positioned in the opening may be moved to another location (e.g., on the same circuit board or a different circuit board) and connected to the radiator (e.g., using one or more vias and/or traces). Accordingly, the patch antennas described herein may be modified in any of a variety of ways without departing from the scope of the present disclosure.

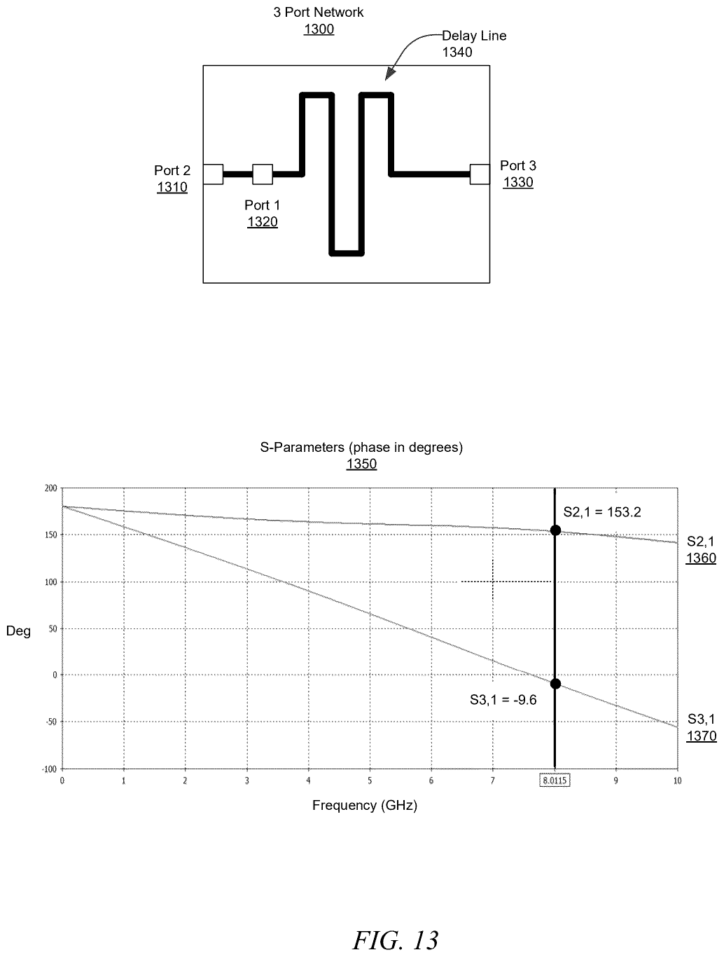

FIG. 13 illustrates simulation results for an example three port network 1300 that may be employed to achieve the phase shift described above with respect to patch antenna 900-1200. The network 1300 is configured to receive a signal through a first port 1320 and to split the signal for delivery through a second port 1310 and a third port 1330, for example to feed portions of a radiator. The signal delivered through the third port 1330 travels through delay line 1340 which is configured to impart a phase shift of 180 degrees at the frequency of interest, which in this example is 8.0115 GHz. A plot of the S-parameters 1350 resulting from the simulation of the network 1300 is shown. The S-parameters 1350 illustrate relative phase in degrees as a function of frequency. The top plot S2,1 1360 shows the phase difference between the first and second ports, which is 153.2 degrees at 8.0115 GHz. The bottom plot S3,1 1370 shows the phase difference between the first and third ports, which is −9.6 degrees at 8.0115 GHz. The resulting difference between S2,1 and S31,1 at that frequency is 162.8 degrees.

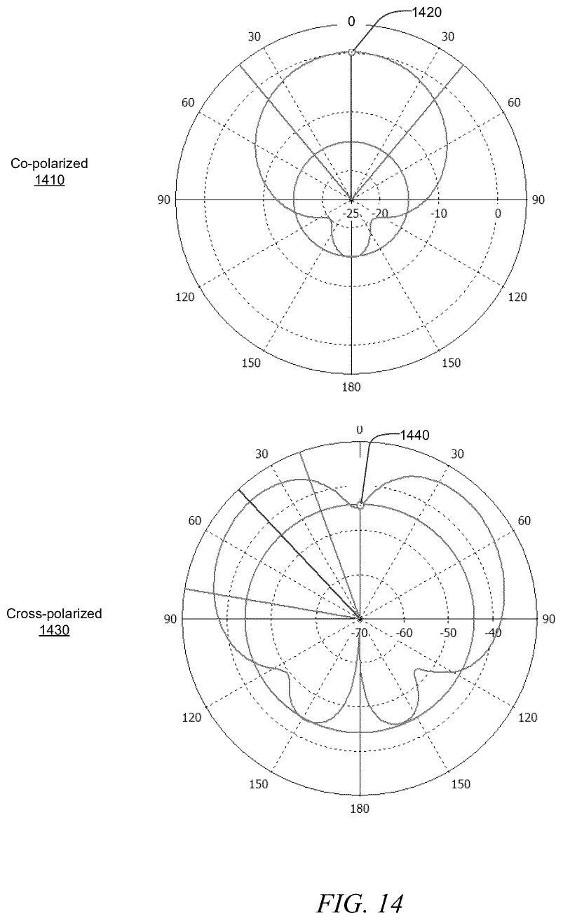

FIG. 14 illustrates simulated radiation patterns 1400 for an example patch antenna driven by the three port network 1300 described above. Plot 1410 illustrates the co-polarized radiation pattern and plot 1430 illustrates the cross-polarized radiation pattern. As shown in the plots, the co-polarized radiation peaks at a realized gain of 0 dBi, at the boresight 1420 of the antenna (e.g., zero degrees). The corresponding cross-polarized radiation at zero degrees 1440 is at a realized gain of −45 dBi. This achieves 45 dB of cross-polarized isolation which is an improvement of about 10 dB over the performance of a conventional patch antenna driven by a single feed source that is connected at one point along an outer edge of the patch.

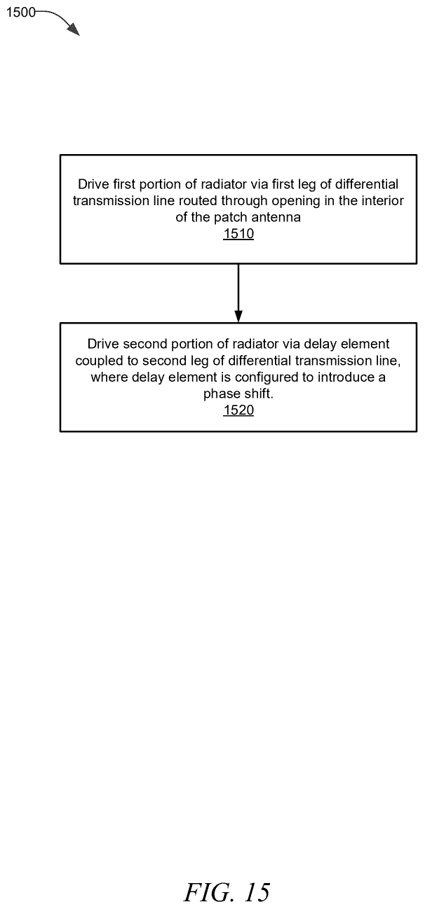

FIG. 15 is a flowchart illustrating an example method 1500 for driving a patch antenna to provide reduced cross-polarization. While the method is generally applicable to any of the patch antennas shown in FIGS. 9-12, the following example will refer to patch antenna 900.

Method 1500 commences at block 1510, which includes driving a first portion of a radiator of a patch antenna with a signal provided via a first leg of a differential feed. At block 1520, the method 1500 further includes driving a second portion of the radiator of the patch antenna with the signal provided via a delay element coupled to a second leg of the differential feed. The delay element is configured to introduce a phase shift to the signal provided to the second portion of the radiator. In some examples, the delay element is configured to introduce a 180 degree phase shift to the signal.

In some examples, the radiator is disposed on a dielectric substrate and the substrate is disposed on an electrically conductive ground plane.

In some examples, the delay element is a delay line of a length selected to introduce the desired phase shift to the signal. In some examples, the delay element is a lumped element circuit comprising one or more capacitive elements and/or inductive elements configured to introduce the desired phase shift to the signal.

In some examples, the delay element is an RFIC configured to introduce the desired phase shift to the signal. The RFIC may be located within or beneath the opening in the interior region of the patch antenna. In some examples, the RFIC may be configured as a wireless radio employed to transmit and receive signals for a playback device.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. Example Features

The following examples pertain to further embodiments, from which numerous permutations and configurations will be apparent.

(Feature 1) A playback device comprising: a patch antenna comprising: an electrically conductive ground plane; a substrate disposed on the ground plane; a radiator disposed on the substrate, the radiator comprising a first portion and a second portion, wherein the first portion of the radiator is coupled through an opening in an interior region of the patch antenna to a first leg of a differential feed, the differential feed configured to provide a signal to drive the radiator; and a delay element, wherein the second portion of the radiator is coupled via the delay element and further through the opening of the patch antenna to a second leg of the differential feed; a wireless radio coupled to the patch antenna via the differential feed; at least one processor; at least one non-transitory computer-readable medium comprising program instructions that are executable by the at least one processor such that the playback device is configured to: based on signals received via the patch antenna from another playback device, determine a relative location of the playback device to the other playback device; and operate in a playback configuration where the playback device plays back one or more channels of multi-channel audio content, the playback configuration based on the determined relative location.

(Feature 2) The playback device of feature 1, wherein the opening in the interior region of the patch antenna is centrally located within the radiator.

(Feature 3) The playback device of feature 1, wherein the delay element is a lumped element circuit comprising one or more capacitive elements and/or inductive elements configured to introduce a phase shift to the signal.

(Feature 4) The playback device of feature 3, wherein the delay element is configured to introduce a 180 degree phase shift to the signal.

(Feature 5) The playback device of feature 1, wherein the delay element is a delay line of a length selected to introduce a 180 degree phase shift to the signal.

(Feature 6) The playback device of feature 5, wherein the delay line is tunable to provide a variable delay based on a frequency band of the signal.

(Feature 7) The playback device of feature 1, wherein the delay element is a radio frequency integrated circuit (RFIC) configured to introduce a 180 degree phase shift to the signal.

(Feature 8) The playback device of feature 7, wherein the RFIC is located within the opening in the interior region of the patch antenna.

(Feature 9) The playback device of feature 7, wherein the RFIC is located beneath the opening in the interior region of the patch antenna.

(Feature 10) The playback device of feature 7, wherein the RFIC comprises the wireless radio.

(Feature 11) The playback device of feature 10, wherein the wireless radio is an ultrawideband (UWB) radio and wherein the signal is a UWB signal.

(Feature 12) The playback device of feature 1, wherein the substrate is a dielectric material.

(Feature 13) The playback device of feature 1, the patch antenna further comprises one or more parasitic elements located adjacent to opposite edges of the patch antenna.

(Feature 14) The playback device of feature 1, wherein the differential feed is a coaxial cable.

(Feature 15) The playback device of feature 1, wherein the differential feed is a microstrip transmission line.

(Feature 16) The playback device of feature 1, wherein the patch antenna is a printed circuit board (PCB) and the opening in the interior region of the patch antenna is a via through the ground plane and the substrate.

(Feature 17) The playback device of feature 1, wherein the delay element is configured to match an impedance of the second leg of the differential feed.

(Feature 18) A patch antenna comprising: an electrically conductive ground plane; a substrate disposed on the ground plane; a radiator disposed on the substrate, the radiator comprising a first portion and a second portion, wherein the first portion of the radiator is coupled through an opening in an interior region of the patch antenna to a first leg of a differential feed, the differential feed configured to provide a signal to drive the radiator; and a delay element, wherein the second portion of the radiator is coupled via the delay element and further through the opening of the patch antenna to a second leg of the differential feed.

(Feature 19) The patch antenna of feature 18, wherein the opening in the interior region of the patch antenna is centrally located within the radiator.

(Feature 20) The patch antenna of feature 18, wherein the delay element is a lumped element circuit comprising one or more capacitive elements and/or inductive elements configured to introduce a phase shift to the signal.

(Feature 21) The patch antenna of feature 20, wherein the delay element is configured to introduce a 180 degree phase shift to the signal.

(Feature 22) The patch antenna of feature 18, wherein the delay element is a delay line of a length selected to introduce a 180 degree phase shift to the signal.

(Feature 23) The patch antenna of feature 22, wherein the delay line is tunable to provide a variable delay based on a frequency band of the signal.

(Feature 24) The patch antenna of feature 18, wherein the delay element is a radio frequency integrated circuit (RFIC) configured to introduce a 180 degree phase shift to the signal.

(Feature 25) The patch antenna of feature 24, wherein the RFIC is located within the opening in the interior region of the patch antenna.

(Feature 26) The patch antenna of feature 24, wherein the RFIC is located beneath the opening in the interior region of the patch antenna.

(Feature 27) The patch antenna of feature 24, wherein the RFIC is further configured as a wireless radio.

(Feature 28) The patch antenna of feature 27, wherein the wireless radio is an ultrawideband (UWB) radio and wherein the signal is a UWB signal.

(Feature 29) The patch antenna of feature 18, wherein the substrate is a dielectric material.

(Feature 30) The patch antenna of feature 18, further comprising one or more parasitic elements located adjacent to opposite edges of the patch antenna.

(Feature 31) The patch antenna of feature 18, wherein the differential feed is a coaxial cable.

(Feature 32) The patch antenna of feature 18, wherein the differential feed is a microstrip transmission line.

(Feature 33) The patch antenna of feature 18, wherein the patch antenna is a printed circuit board (PCB) and the opening in the interior region of the patch antenna is a via through the ground plane and the substrate.

(Feature 34) The patch antenna of feature 18, wherein the delay element is configured to match an impedance of the second leg of the differential feed.

(Feature 35) A media playback system comprising: a first playback device; and a second playback device, wherein the first playback device comprises: a patch antenna including: an electrically conductive ground plane; a substrate disposed on the ground plane; a radiator disposed on the substrate, the radiator comprising a first portion and a second portion, wherein the first portion of the radiator is coupled through an opening in an interior region of the patch antenna to a first leg of a differential feed, the differential feed configured to provide a signal to drive the radiator; and a delay element, wherein the second portion of the radiator is coupled via the delay element and further through the opening of the patch antenna to a second leg of the differential feed; a wireless radio coupled to the patch antenna via the differential feed; at least one processor; at least one non-transitory computer-readable medium comprising program instructions that are executable by the at least one processor such that the first playback device is configured to: based on signals received via the patch antenna from the second playback device, determine a relative location of the first playback device to the second playback device; and operate in a playback configuration where the first playback device plays back one or more channels of multi-channel audio content, the playback configuration based on the determined relative location.

What is claimed is:

1. A playback device comprising:
a patch antenna comprising:
an electrically conductive ground plane;
a substrate disposed on the ground plane;
a radiator disposed on the substrate, the radiator comprising a first portion and a second portion, wherein the first portion of the radiator is coupled through an opening in an interior region of the patch antenna to a first leg of a differential feed, the differential feed configured to provide a signal to drive the radiator; and
a delay element, wherein the second portion of the radiator is coupled via the delay element and further through the opening of the patch antenna to a second leg of the differential feed;
a wireless radio coupled to the patch antenna via the differential feed;
at least one processor;
at least one non-transitory computer-readable medium comprising program instructions that are executable by the at least one processor such that the playback device is configured to:
based on signals received via the patch antenna from another playback device, determine a relative location of the playback device to the other playback device; and
operate in a playback configuration where the playback device plays back one or more channels of multi-channel audio content, the playback configuration based on the determined relative location.

2. The playback device of claim 1, wherein the opening in the interior region of the patch antenna is centrally located within the radiator.

3. The playback device of claim 1, wherein the delay element is a lumped element circuit comprising one or more capacitive elements and/or inductive elements configured to introduce a phase shift to the signal.

4. The playback device of claim 3, wherein the delay element is configured to introduce a 180 degree phase shift to the signal.

5. The playback device of claim 1, wherein the delay element is a delay line of a length selected to introduce a 180 degree phase shift to the signal.

6. The playback device of claim 5, wherein the delay line is tunable to provide a variable delay based on a frequency band of the signal.

7. The playback device of claim 1, wherein the delay element is a radio frequency integrated circuit (RFIC) configured to introduce a 180 degree phase shift to the signal.

8. The playback device of claim 7, wherein the RFIC is located within the opening in the interior region of the patch antenna or beneath the opening in the interior region of the patch antenna.

9. The playback device of claim 7, wherein the RFIC comprises the wireless radio.

10. The playback device of claim 1, the patch antenna further comprises one or more parasitic elements located adjacent to opposite edges of the patch antenna.

11. A patch antenna comprising:
an electrically conductive ground plane;
a substrate disposed on the ground plane;
a radiator disposed on the substrate, the radiator comprising a first portion and a second portion, wherein the first portion of the radiator is coupled through an opening in an interior region of the patch antenna to a first leg of a differential feed, the differential feed configured to provide a signal to drive the radiator; and
a delay element, wherein the second portion of the radiator is coupled via the delay element and further through the opening of the patch antenna to a second leg of the differential feed.

12. The patch antenna of claim 11, wherein the opening in the interior region of the patch antenna is centrally located within the radiator.

13. The patch antenna of claim 11, wherein the delay element is a lumped element circuit comprising one or more capacitive elements and/or inductive elements configured to introduce a phase shift to the signal and the delay element is configured to introduce a 180 degree phase shift to the signal.

14. The patch antenna of claim 11, wherein the delay element is a delay line of a length selected to introduce a 180 degree phase shift to the signal.

15. The patch antenna of claim 11, wherein the delay element is a radio frequency integrated circuit (RFIC) configured to introduce a 180 degree phase shift to the signal.

16. The patch antenna of claim 15, wherein the RFIC is located within the opening in the interior region of the patch antenna or beneath the opening in the interior region of the patch antenna.

17. The patch antenna of claim 11, further comprising one or more parasitic elements located adjacent to opposite edges of the patch antenna.

18. The patch antenna of claim 11, wherein the differential feed is a coaxial cable or a microstrip transmission line.

19. The patch antenna of claim 11, wherein the patch antenna is a printed circuit board (PCB) and the opening in the interior region of the patch antenna is a via through the ground plane and the substrate.

20. A media playback system comprising:
a first playback device; and
a second playback device, wherein the first playback device comprises:
a patch antenna including:
an electrically conductive ground plane;
a substrate disposed on the ground plane;
a radiator disposed on the substrate, the radiator comprising a first portion and a second portion, wherein the first portion of the radiator is coupled through an opening in an interior region of the patch antenna to a first leg of a differential feed, the differential feed configured to provide a signal to drive the radiator; and
a delay element, wherein the second portion of the radiator is coupled via the delay element and further through the opening of the patch antenna to a second leg of the differential feed;
a wireless radio coupled to the patch antenna via the differential feed;
at least one processor;
at least one non-transitory computer-readable medium comprising program instructions that are executable by the at least one processor such that the first playback device is configured to:
based on signals received via the patch antenna from the second playback device, determine a relative location of the first playback device to the second playback device;
and operate in a playback configuration where the first playback device plays back one or more channels of multi-channel audio content, the playback configuration based on the determined relative location.
